(19) United States
(12) Patent Application Publication
(10) Pub. No.: US 2025/0304016 A1
(43) Pub. Date: Oct. 2, 2025

(54) WINDSHIELD RUNOFF AND RAIN CLEARING SYSTEMS AND METHODS

(71) Applicant: TOYOTA MOTOR ENGINEERING & MANUFACTURING NORTH AMERICA, INC., PLANO, TX (US)

(72) Inventor: JESSE DWAYNE RYDELL, Ann Arbor, MI (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/622,679

(22) Filed: Mar. 29, 2024

(51) Int. Cl. B60S 1/54

(52) U.S. Cl. CPC B60S 1/548; B60S 1/542

(57) ABSTRACT

Gas such as air can be expelled selectively (e.g., varied intensity/gas pressure, amount of gas expelled, direction, etc.) from one or more nozzles provided on a windshield wiper assembly. The amount, direction, speed, and/or pressure at which the gas is expelled from the nozzle can be selectively controlled according to the needs of the vehicle, as well as any conditions, e.g., environmental conditions, in response to which the vehicle's windshield wiper(s) are enabled. In this way, the accumulation, overflow, or runoff of fluid/debris near or at the A-pillars of the vehicle can be wiped away.

### TECHNICAL FIELD

The present disclosure relates generally to systems and methods for reducing or eliminating windshield runoff, and, more particularly, some embodiments relate to windshield wiping systems and methods with controllable gas output for redirecting rain/runoff.

### DESCRIPTION OF RELATED ART

Vehicles, such as automotive vehicles, are equipped with windshield wiper systems for ensuring a clear view through front and/or rear windshields of the vehicle. Windshield wiper systems generally includes a wiper driver (or motor/actuator) coupled to one or more wiper arms. The wiper driver rotates a fixed pivot point, which causes each wiper arm to move across the windshield (or a portion(s) thereof) in a back and forth (sometimes arcuate) direction. The wiper arms are coupled to elastomer blades that contact the windshield, and act to wipe fluid, debris, and the like from the windshield by being slid or dragged (by the wiper arms to which the elastomer blades are coupled) across a surface of the windshield.

When debris, such as dust, accumulates on the windshield, washer fluid can be sprayed onto the windshield and then wiped away via the elastomer blade. Generally, washer fluid is sprayed from spray nozzles provided in a panel between the windshield and a hood of the vehicle (i.e., the cowl of the vehicle), in the case of a front windshield. In the case of a rear windshield, a spray nozzle is generally disposed adjacent to the wiper arm and formed within weather stripping at an edge of the windshield.

### BRIEF SUMMARY OF THE DISCLOSURE

In accordance with some embodiments, a method comprises determining, by a control circuit, conditions impacting operation of a windshield wiper system, and determining, by the control circuit and based on the determined conditions, whether redirection of at least one of fluid or debris present on a windshield is warranted. Upon a determination that redirection of the least one of fluid or debris present on the windshield, operating parameters for the windshield wiper system are determined. Moreover, the method further comprises operating, by the control circuit, the windshield wiper system in accordance with the determined operating parameters for the windshield wiper system to redirect the at least one of the fluid or debris present on the windshield.

In some embodiments, the determined operating parameters comprise at least one of a direction of operation and an intensity of operation of the windshield wiper system. In some embodiments, the windshield wiper system comprises at least one nozzle configured to expel a gas to effectuate redirection of the at least one of the fluid or debris on the windshield, the direction of operation comprising directing the at least one nozzle in a direction to effectuate the redirection of the at least one of the fluid or debris on the windshield.

In some embodiments, determining whether redirection of at least one of fluid or debris present on a windshield is warranted comprises the control circuit receiving sensor information regarding the presence of an accumulation of or runoff made up of the at least one of the fluid or debris proximate to a vehicle A-pillar.

In accordance with another embodiment, a system comprises a wiper blade, and a wiper arm operatively connected to the wiper blade and to an actuator configured to move the wiper arm on a surface such that the wiper blade follows a path for clearing at least one of fluid or debris from the path on the surface. The system further comprises a nozzle configured to expel gas to redirect at least one of accumulated or runoff fluid or debris outside the path to within the path allowing the wiper blade to clear the at least one of the redirected accumulated or runoff fluid or debris.

In some embodiments, the system further comprises a nozzle control circuit controlling the expelling of the gas from the nozzle. In some embodiments, the nozzle control circuit controls at least one of a direction in which the gas is expelled from the nozzle, an amount of gas that is expelled from the nozzle, and a pressure at which the gas is expelled from the nozzle.

In some embodiments, the system further comprises another wiper blade, and another wiper arm operatively connected to the other wiper blade and to another actuator configured to move the other wiper arm on a surface such that the other wiper blade follows another path for clearing at least one of fluid or debris from the other path on the surface. Additionally still, the system further comprises another nozzle configured to expel additional gas to redirect at least one of accumulated or runoff fluid or debris outside the other path to within the other path allowing the other wiper blade to clear the at least one of the redirected accumulated or runoff fluid or debris. In some embodiments, the nozzle control circuit further controls the expelling of the additional gas from the other nozzle. In some embodiments, the nozzle control circuit controls at least one of a direction in which the additional gas is expelled from the other nozzle, an amount of the additional gas that is expelled from the other nozzle, and a pressure at which the additional gas is expelled from the other nozzle. In some embodiments, the nozzle control circuit separately controls the expelling of the gas and the additional gas from the nozzle and the other nozzle, respectively.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic illustration of an example windshield wiper system according to embodiments of the presently disclosed technology.

FIG. 2 illustrates an example architecture for controlling the output of gas in accordance with one embodiment of the systems and methods described herein

FIG. 3A is a schematic illustration of the example windshield wiper system of FIG. 1 in a first scenario.

FIG. 3B is a schematic illustration of the example windshield wiper system operating to address fluid/debris accumulation and/or runoff in the first scenario of FIG. 3A.

FIG. 3C is another schematic illustration of the example windshield wiper system operating to address fluid/debris accumulation and/or runoff in the first scenario of FIG. 3A.

FIG. 4A is a schematic illustration of the example windshield wiper system of FIG. 1 in a second scenario.

FIG. 4B is a schematic illustration of the example windshield wiper system operating to address fluid/debris accumulation and/or runoff in the second scenario of FIG. 4A.

FIG. 5 is a schematic illustration of the example windshield wiper system operating to address fluid/debris accumulation and/or runoff in a third scenario in accordance with one embodiment of the presently disclosed technology.

FIG. 6 illustrates various operations performed to address fluid and/or debris runoff or accumulation in accordance with some embodiments of the presently disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

As alluded to above, conventional windshield washer systems can include a container with washer fluid therewithin. In addition, conventional windshield washer systems can include a pump that forces the washer fluid through a washer fluid line and spray nozzles onto the windshield. Such washer fluid systems can be used to assist in the removal of debris, bugs, etc. from the windshield. Further still, typical windshield washer systems include one or more (usually two for the front windshield, one for the rear windshield) windshield wiper assemblies. A windshield wiper assembly may include a windshield wiper blade attached to one end of a windshield wiper arm, with the other end of the windshield wiper arm being operatively connected to and operated vis-à-vis an actuator or motor.

Typically, the aforementioned spray nozzles are located on a windshield wiper arm or mounted proximate to a lower/bottom section of a front windshield sometimes atop a vehicle's hood or in a cowl between the vehicle's hood and an outer surface of the windshield. In the case of rear windshields, spray nozzles can be positioned either near an upper section of the rear windshield or a lower section of the rear windshield. Regardless of placement, the spray nozzles direct washer fluid onto the windshield, while the windshield wiper arms, if turned on, rotate or otherwise move to effectuate “dragging” of their corresponding windshield wiper blades across the outer windshield surface to wipe away or clear the washer fluid.

However, the accumulation of fluid and the movement of the windshield wiper blades can often cause fluid (rain and/or washer fluid) overflow and runoff at either side of the outer windshield surface, near or at the A-pillars of the vehicle. The overflow/runoff of excess fluid from the windshield results in fluid flow over the A-pillar toward sides windows the vehicle, which can impact visibility from the side windows. Further, overflow and/or runoff can impact neighboring vehicles. For example, excess fluid on the windshield during high speed travel, such as on express ways, can blow back onto a following vehicle, which can be unsafe from a visibility perspective.

Conventionally, the problem of overflow and runoff has been solved by increasing the height of an A-pillar of the vehicle or by adding rain gutters. However, these approaches generally try to obstruct fluid overflow and runoff. Thus, overflow and runoff onto side windows can still occur, such as when there is a higher degree of fluid accumulation that cannot be “held back” or redirected even by way of using these conventional approaches.

In accordance with another conventional solution, spray nozzles that are located on the windshield wipers themselves can provide a localized fluid spray onto specific regions of a windshield over which the wiper blades travel. However, this conventional solution can still result in overflow and runoff as the sprayed fluid can flow from an initially sprayed location to an outer edge of the windshield near the A-pillar and accumulate, thereby causing overflow and runoff.

Embodiments disclosed herein overcome the above-described short comings of conventional windshield clearing/wiping approaches through selectively expelling gas (e.g., varied intensity/gas pressure, amount of gas expelled, etc.), such as but not limited to air, from one or more nozzles provided on a windshield wiper assembly. For example, the one or more nozzles can be provided in a location, such as a cowl between or proximate to the windshield and hood of a vehicle. An amount, direction, speed, and/or pressure at which the gas is expelled from the nozzle can be selectively controlled according to the needs of the vehicle, as well as any conditions, e.g., environmental conditions, in response to which the vehicle's windshield wiper(s) are enabled. For example, a reduction in windshield wiper runoff can be achieved by expelling gas in a direction dependent on the position of a wiper blade with respect to a windshield of the vehicle. Orientations of the one or more nozzles can be controlled so to expel gas in a desired direction. By controlling the direction, excess fluid on the windshield can be directed away from one edge of the windshield (e.g., a driver side edge) toward another edge of the windshield (e.g., upper edge) of the windshield to reduce runoff and overflow over the A-pillar. Similarly, the amount of gas flow (e.g., a measure of gas output in terms of volume per unit of time), pressure (e.g., a measure of force applied to the nozzle opening through which gas is expelled), and/or velocity (e.g., how fast the gas is moving in distance per unit of time) at which the gas is expelled from the one or more nozzles can be controlled based on the position of the wiper blade, the amount of water/debris to be removed or redirected, etc.

Embodiments disclosed herein can determine a location and/or direction of travel of the windshield wipers on the surface of the windshield, and can effectuate control of the one or more nozzles based on the determined location and/or direction. For example, embodiments disclosed herein may utilize sensor data, such as, but not limited to, image data, radar data, LiDAR data, and so on to determine the location of the windshield wiper(s) along the outer surface (e.g., exterior of the vehicle cabin) of the windshield. In one example, when the windshield wipers are located adjacent to a bottom edge of the windshield and the windshield wipers are moving in a direction towards an upper edge of the windshield, embodiments disclosed herein may be configured to output gas from the one or more nozzles in a direction toward the upper edge, and/or in a direction towards a center area of the windshield, thereby redirecting any fluid on the surface of the windshield toward the upper edge and possibly above the vehicle, and/or towards the center and away from the side edges (towards A pillars). This allows the windshield wipers to wipe away would might otherwise result in liquid/debris runoff at the edge(s) of the travel path of the windshield wipers proximate to the A pillars of the vehicle.

In another example, when the windshield wipers are adjacent to the upper edge of the windshield and moving in a direction towards the bottom edge of the windshield, the one or more nozzles can be controlled, in this case, selectively or purposely disabled/prevented from outputting gas. That is, when windshield wipers are moving in a downward trajectory, for example, typically no runoff or less runoff at the A pillars or sides of the windshield occurs. This is because the direction of movement of the windshield wipers facilitates “collection” of any water/debris towards the center of the windshield where the windshield wipers will already travel. Thus, offsetting measures, i.e., the nozzles, are not necessarily needed at all times.

Embodiment disclosed herein can vary an amount of gas flow (e.g., air flow rate) of the gas output by the one or more nozzles. For example, embodiments disclosed herein can determine an amount of washer fluid and/or rain is present on the windshield surface. If the determined amount is below a set threshold amount, the one or more nozzles may be controlled to output gas at a lower flow rate to remove the amount the wiper fluid and/or rain. If, on the other hand, a large amount of fluid and/or rain is present on the windshield (e.g., above the set threshold), the one or more nozzles can be controlled to output gas at a higher flow rate to remove the washer fluid and/or rain. The flow rate may be controlled by adjusting a volume (e.g., an amount) of gas output per unit of time, a pressure and/or velocity at which the gas is expelled. For example, increasing the volume of gas forced through the nozzle for a unit of time can increase the pressure and velocity of the gas, which increases the flow rate. Accordingly, embodiments disclosed herein can vary the volume and/or flow rate of the gas from a minimum value (e.g., none) to a maximum value based on an amount of fluid (e.g., washer fluid and/or rain) detected on the windshield. The volume and/or flow rate may be proportional to the amount of fluid present on the windshield.

In another example, embodiments disclosed herein can control which nozzles of a plurality of nozzles output gas. For example, each windshield wiper assembly of a pair of windshield wiper assemblies may comprise one or more nozzles, such that a first windshield wiper assembly comprises a first one or more nozzles and a second windshield wiper assembly comprises a second one or more nozzles. Embodiments disclosed herein may use sensor data, such as, but not limited to, image data, radar data, LIDAR data, and so on to determine which areas of the surface of the windshield have fluid present thereon. For example, a first area (e.g., driver side area of the windshield) of the windshield may correspond to a first windshield wiper assembly and a second area (e.g., passenger side area) may correspond to a second windshield wiper assembly. If, for example, fluid is detected on the first area and not on the second area, embodiments disclosed herein may output gas from first one or more nozzles of the first windshield wiper assembly, while not outputting gas from the second one or more nozzles. As described above, in addition to controlling which one or more nozzles output gas, the embodiments disclosed herein can control the timing of when the one or more nozzles output gas (e.g., the nozzles can be controlled to only output gas when the wipers are moving down towards the bottom of the windshield).

In another example where a given windshield wiper comprises a plurality of nozzles, embodiments disclosed herein can control which of the plurality of nozzles expel gas by detecting which sub-region(s) of an area corresponding to the windshield has undesired liquid/debris thereon. The embodiments disclosed herein may detect fluid present in one or more regions/sub-regions pf a windshield, and trigger one or more nozzles corresponding to the regions/sub-regions on which fluid is detected. As another example, one or more nozzles may be triggered to output gas to collectively direct the fluid to reduce runoff and overflow.

Some embodiments can be configured to control the one or more nozzles to output gas responsive to detecting rain present on the windshield. . . . If the system determines that it is lightly raining (detecting small rain drops or detecting some threshold amount of time between successively-sensed rain drops, for example), the nozzles may be controlled to output gas at a low flow rate as the windshield wipers move down toward the bottom edge of the windshield to clear the windshield of rain. If it is determined that there is a heavy downpour (larger rain drops, greater frequency of rain drops contacting an outer surface of a windshield, etc.), nozzles may be controlled to output gas at a high speed as the wipers move down toward the bottom of the windshield to clear the windshield of rain. Moreover, as the windshield wipers move up toward the top edge of the windshield, embodiments disclosed herein may control nozzle operation to prevent the output of gas.

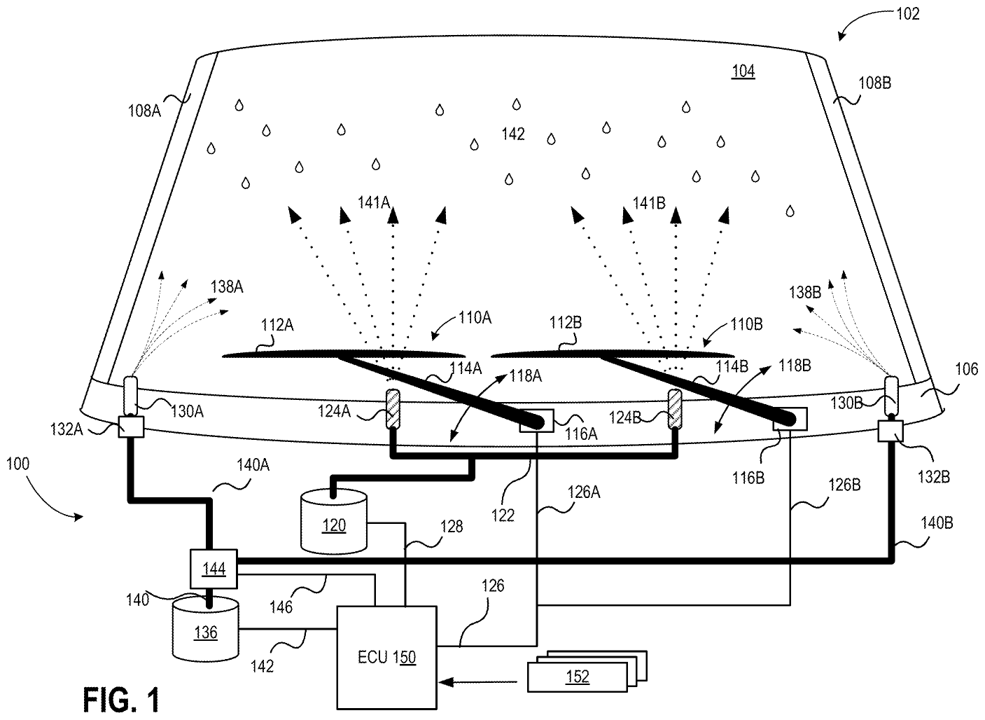

FIG. 1 is a schematic illustration of a windshield wiper system 100 according to embodiments of the presently disclosed technology. The windshield wiper system 100 includes windshield wiper assemblies 110A and 110B that can be operated to clear/clean a windshield 104 of a vehicle 102. Each windshield wiper assembly 110A and 110B includes an elastomer blade 112A and 112B, respectively, attached to one end (e.g., the distal end) of windshield wiper arms 114A and 114B, respectively, with the other end (e.g., proximal end) of the windshield wiper arms 114A and 114B being operatively connected to and operated vis-à-vis actuators 116A and 116B, respectively. An electronic control unit (ECU) 150 may operate to supply wiper control signals over communication lines 126A and 126B (e.g., wired or wireless communication interface) to activate the actuators 116A and 116B so to cause the windshield wiper arms 114A and 114B to move across the windshield104 back and forth along wiper travel paths 118A and 118B, respectively. As a result, the blades 112A and 112B are dragged or slid across the surface of the windshield 104 so to wipe any fluid, debris, and the like from the surface of the windshield 104.

In some embodiments, the windshield wiper system 100 includes a container or other receptacle 120 containing a liquid fluid (e.g., washer fluid 141A/B) and a pump (not shown). The container 120 can be coupled to a liquid line 122 that affords for the liquid to be forced through one or more liquid spray nozzles or jets 124A and 124B (liquid. In the example of FIG. 1, the liquid spray nozzles 124A and 124B are provided in a cowl 106 of the vehicle; however, the liquid spray nozzles 124A and 124B can be provided at other locations, e.g., along or relative to a top portion of windshield 104. For example, rear windshields typically utilize above-mounted windshield wiper assemblies and above-mounted wiper fluid liquid spray nozzles. In this manner, the fluid can be sprayed onto the windshield 104. Such fluid, as alluded to above, is typically meant to loosen any debris on an outer surface of windshield 104, or to provide a cleaning medium with which to reduce water spots, streaking, other residue buildup, etc. An ECU 150 may operate to supply a washer control signal over a communication line 126 to energize the pump so as to cause the liquid to be sprayed onto the windshield 104.

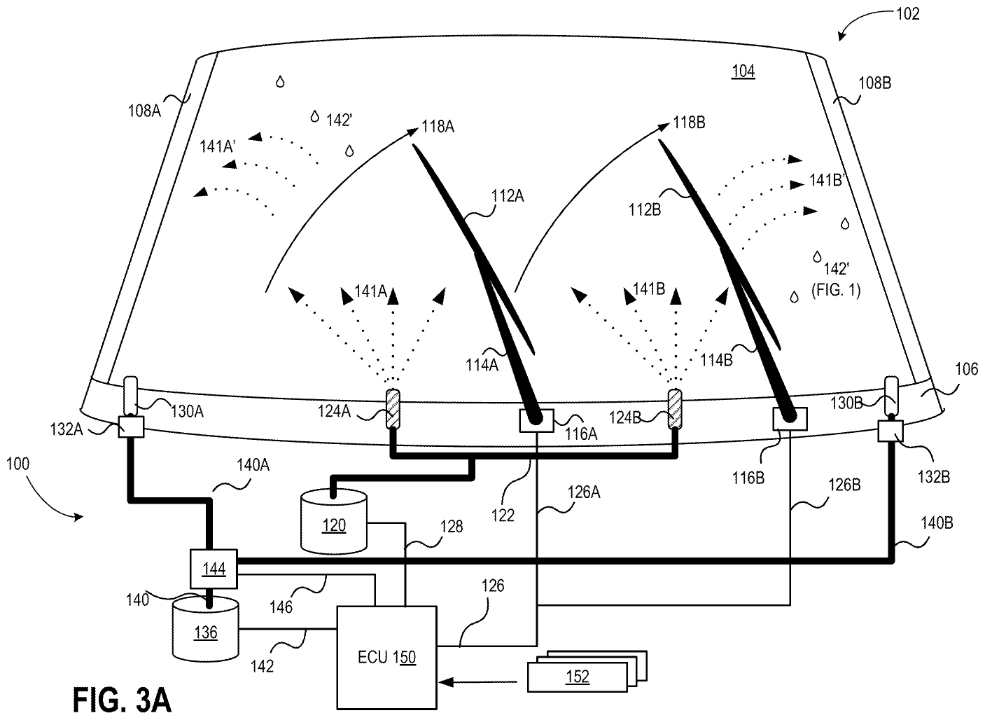

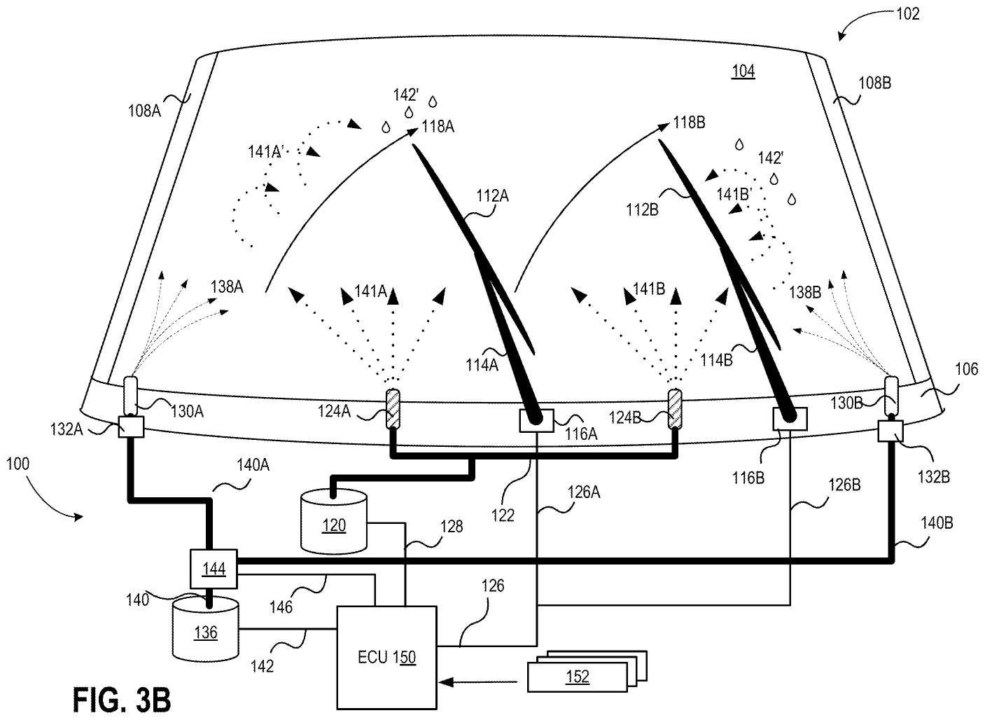

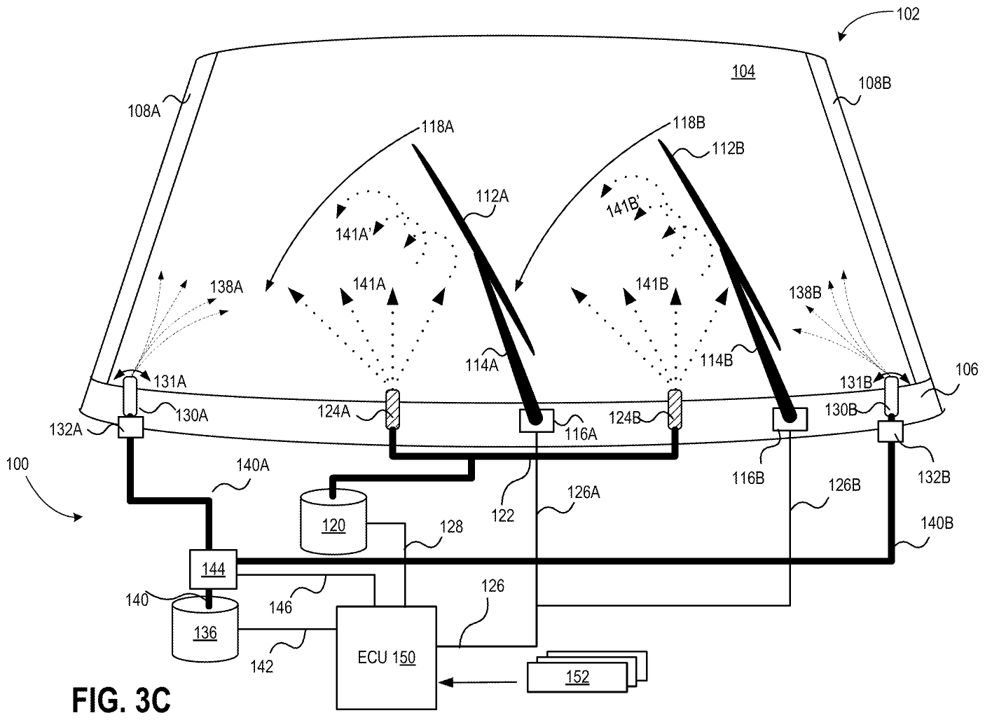

It should be noted that aside from wiper washer fluid 141A/B, rain or other debris 142 (FIG. 1), can also be present and/or pushed/moved by the action of wiper blades 112A/B, resulting in such rain/debris 142 also accumulating near A-pillars 108A/B (FIG. 3A).

The windshield wiper system 100 further includes a first one or more gas nozzles 130A and a second one or more gas nozzles 130B disposed in cowl 106 of vehicle 102. In some examples, a gas nozzle 130A can be disposed in cowl 106 near a first side of windshield 104, e.g., the left side of windshield 104 when facing the outer surface of windshield 104, while another gas nozzle 130B can also be disposed in cowl 106.

In some examples, first and second one or more gas nozzles 130A and 130B may be operatively connected to and operated vis-à-vis actuators 132A and 132B, respectively. In this case, ECU 150 may operate control the actuators 132A and 132B so to cause the actuators 132A and 132B to change an orientation of the one or more gas nozzles 130A and 130B, respectively. For example, as discussed above, it may be desirable to redirect the flow of runoff, and to do so, in some embodiments, the orientation of a gas nozzle is controlled so that the direction in which the gas is output from the gas nozzle redirects/directs runoff, dirt, etc., in the desired manner. As a result, the one or more gas nozzles 130A and 130B can be directed to various areas of the windshield 104 according to the needs and characteristics of the vehicle and/or conditions. In an example, communications lines 126A and 126B may represent multiple communications lines, where communication lines are provided for, e.g., carrying instructions/command signals from ECU 150 to operating actuators 116A and 116B.

The windshield wiper system 100 further includes a compressor or pump 136 operable to force gas 138A and 138B, such as but not limited to, air, through a gas line 140 and out from the one or more gas nozzles 130A and 130B. The compressor or pump 136 can be activated by a ECU 150 according to a gas control signal supplied over communication line 142 so as to energize compressor/pump 136 and force gas 138A and 138B out of the one or more gas nozzles 130A and 130B. As will be discussed below, the ECU 150 can control the compressor/pump 136 so as to force gas through one or more gas nozzles 130A and 130B at varying pressures, flow rates, and/or velocity based on to the operating characteristics of the vehicle. As such, the ECU 150 can be operated to selectively expel gas out from the one or more gas nozzles 130A and 130B so as to direct debris or fluid on the surface of the windshield 104 (e.g., fluid 141A′/B′/142′ into a desired direction, such as away from driver side A-pillar 108B and/or away from driver side A-pillar 108A of the vehicle and thereby reducing runoff and overflow as discussed above.

In some embodiments, windshield wiper system 100 can be configured so to output gas from the one or more gas nozzles 130A and 130B at differing gas flow parameters. For example, windshield wiper system 100 can be operated such that one or more gas nozzles 130A output a first volume of gas, while one or more gas nozzles 130B output a second volume of gas that is different from the first volume. As another example, windshield wiper system 100 can be operated such that one or more gas nozzles 130A output gas at a first flow rate and/or first pressure, while one or more gas nozzles 130B output gas at a second flow rate and/or second pressure. These examples can be utilized to vary operation of the gas nozzle depending on the amount of fluid, debris, etc. that is present in a first region over which the windshield wiper assembly 110A travels as compared to the amount present in a second region over which the windshield wiper assembly 110B travels. That is, larger volumes of gas, flow rates, pressures can be applied to one region to remove larger quantities of fluid, debris, etc., whereas less volume, flow rate, pressure may be needed in another region due to lesser quantities of fluid, debris, etc.

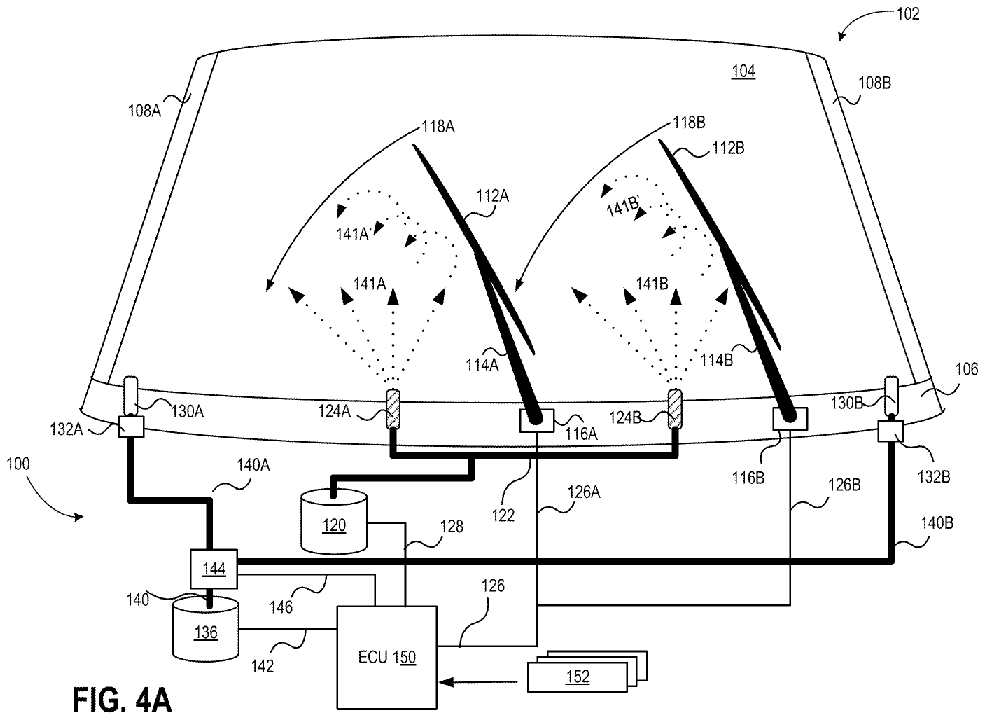

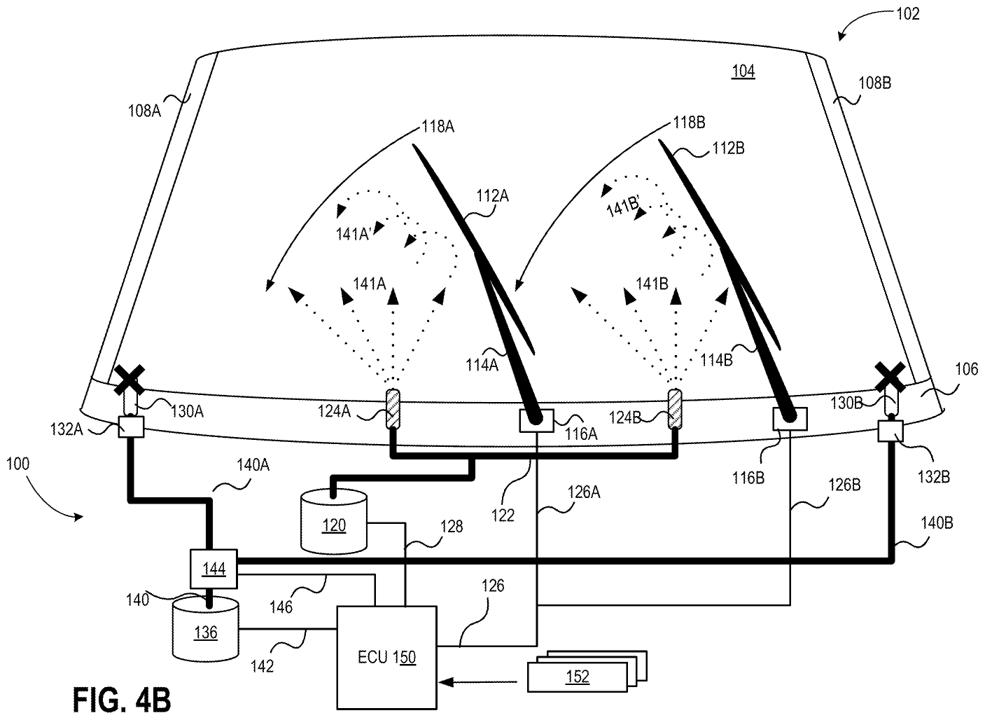

In one example, windshield wiper system 100 can comprise a switch 144 operable to vary an amount of gas supplied from pump 136 to each of the one or more gas nozzles 130A and 130B and/or to enable one, the other, or both gas nozzles 130A/B. For example, compressor/pump 136 may force the gas through gas line 140 to switch 144, which may selectively supply gas to gas lines 140A and 140B based on the operating characteristics of the windshield. The ECU 150 may operate to control the switch 144 via communication line 146 so to cause the switch 144 to change volume, flow rates, and/or pressures of gas supplied to gas lines 140A and 140B according to operating characteristics of the windshield. In another example discussed below in connection with FIG. 4C, compressor/pump 136 may be provided as a plurality of compressors/pumps, each of which can be selectively controlled by the ECU 150 to force gas through a corresponding gas line and output from a corresponding one or more gas nozzles according to the operating characteristics of the windshield.

As alluded to above, ECU 150 can be communicatively coupled to container 120, compressor/pump 136, actuators 116A and 116B, and actuators 132A and 132B. In some cases, communicative coupling can be provided by a wired/electrical connection, while in other cases the communicative coupling may be by a wireless communication interface. In the example of FIG. 1, the communicative coupling is shown as, e.g., communication lines 126, 146, 126A, 126B, and 146.

As alluded to above, windshield wiper system 100 may include an ECU 150. ECU 150 may include circuitry to control various aspects of operation. ECU 150 may include, for example, a microcomputer that includes a one or more processing units (e.g., microprocessors), memory storage (e.g., RAM, ROM, etc.), and I/O devices. The processing units of ECU 150, execute instructions stored in memory to control one or more electrical systems or subsystems in the vehicle. ECU 150 can include a plurality of electronic control units such as, for example, an electronic engine control module, a powertrain control module, a transmission control module, a suspension control module, a body control module, and so on. As a further example, electronic control units can be included to control systems and functions such as windshield wiper system, as well as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, ECU 150 receives information from a plurality of sensors 152 included in the vehicle 102, which may be used to track operating conditions or characteristics of the vehicle 102 and/or windshield 104. For example, ECU 150 may receive signals that indicate vehicle operating conditions or characteristics, or signals that can be used to derive vehicle operating conditions or characteristics. These may include, but are not limited to presence and/or amount of liquid (e.g., rain, washer fluid, etc.) on the windshield 104, position and/or direction of travel of windshield wiper assemblies 110A and 110B. Other example vehicle operating conditions or characteristics can include, but are not limited to, accelerator operation amount, ACC, a revolution speed, NE, of an internal combustion engine (engine RPM), a rotational speed, NMG, of a motor (motor rotational speed), and vehicle speed, NV. Accordingly, windshield wiper system 100 can include a plurality of sensors 152 that can be used to detect various conditions internal or external to the vehicle and provide sensed conditions to ECU 150 (which, again, may be implemented as one or a plurality of individual control circuits).

In some embodiments, one or more of the sensors 152 may include their own processing capability to compute the results for additional information that can be provided to ECU 150. In other embodiments, one or more sensors may be data-gathering-only sensors that provide only raw data to ECU 150. In further embodiments, hybrid sensors may be included that provide a combination of raw data and processed data to ECU 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 102, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of systems with which embodiments of the disclosed technology may be implemented. One of ordinary skill in the art reading this description will understand how the disclosed embodiments can be implemented with this and other vehicle platforms.

Furthermore, while FIG. 1 depicts a front windshield and a windshield wiper system 100 comprising two windshield wiper assemblies, embodiments disclosed herein are not limited to this configuration. Windshield wiper system 100 may comprise fewer or more than two windshield wiper assemblies. For example, windshield wiper system 100 may include a third windshield wiper assembly positioned on a rear windshield, with the distal end adjacent to either an upper or lower edge of the rear windshield. The third windshield wiper assembly may be substantially similar to windshield wiper assembly 110A and driven by ECU 150. One or more gas nozzles may be disposed on the third windshield wiper assembly as described above, which can be used to expel gas provided by the compressor/pump 136 and/or a separate compressor/pump. Further, a spray nozzle may be provided as is known in the art for spraying liquid onto the rear windshield.

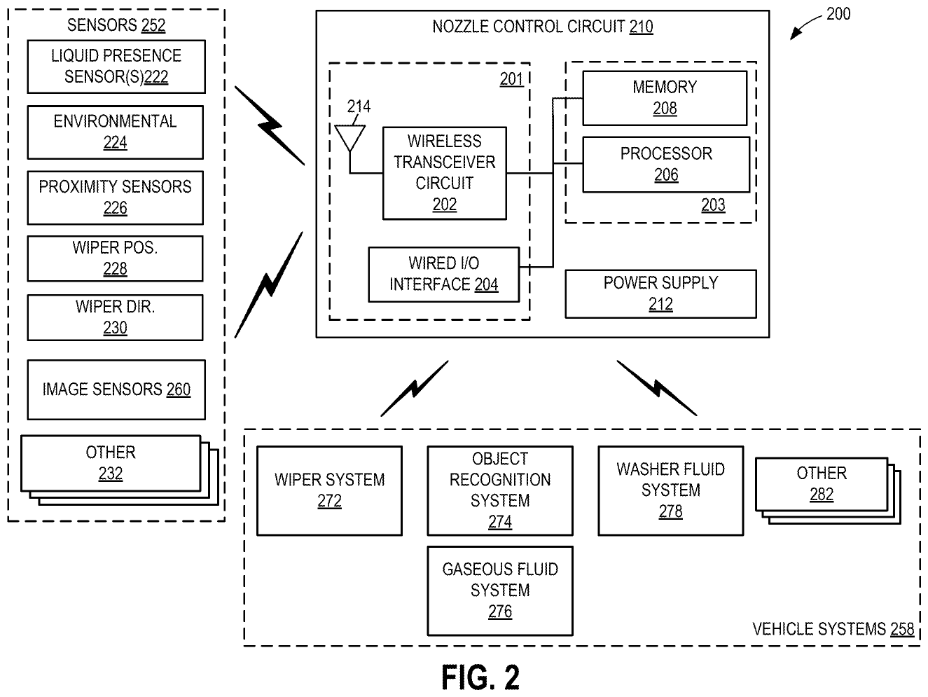

FIG. 2 illustrates an example architecture for controlling the output of gas in accordance with one embodiment of the systems and methods described herein. Referring now to FIG. 2, in this example, nozzle control system 200 includes a nozzle control circuit 210, a plurality of sensors 252 and a plurality of vehicle systems 258. Sensors 252 (such as sensors 152 described in connection with FIG. 1) and vehicle systems 258 can communicate with nozzle control circuit 210 via a wired or wireless communication interface. Although sensors 252 and vehicle systems 258 are depicted as communicating with nozzle control circuit 210, they can also communicate with each other as well as with other vehicle systems. Nozzle control circuit210 can be implemented as an ECU or as part of an ECU such as, for example ECU 150. In other embodiments, nozzle control circuit 210 can be implemented independently of an ECU.

Nozzle control circuit 210 in this example includes a communication circuit 201, a decision circuit 203 (including a processor 206 and memory 208 in this example) and a power supply 212. Components of nozzle control circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: windshield wiper position data; fluid detection data, along with other data as needed. Memory 208 can be made up of one or more modules of one or more different types of memory, and may be configured to store data and other information as well as operational instructions that may be used by the processor 206 to nozzle control circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a nozzle control circuit 210.

Communication circuit 201 includes either or both a wireless transceiver circuit 202 with an associated antenna 214 and a wired I/O interface 204 with an associated hardwired data port (not illustrated).

Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by nozzle control circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 252 such as those described above with reference to the example of FIG. 1. Sensors 252 can include additional sensors that may or may not otherwise be included on a standard vehicle with which the nozzle control system 200 is implemented. In the illustrated example, sensors 252 include liquid presence sensor(s) 222 for detecting a presence of liquid (e.g., rain, wiper fluid, etc.) on a windshield or other windows, environmental sensors 224 (e.g., to detect salinity or other environmental conditions, wind, temperature, etc.), proximity sensor 226 (e.g., sonar, radar, lidar or other vehicle proximity sensors), wiper position sensors 224 to detect a position of a wiper blade with respect to the windshield, wiper direction sensors 326 to detect a direction of travel of the wiper blades. The liquid presence sensor(s) 222 can also be configured to detect an amount of moisture or liquid present on the windshield. Additional sensors 224 can also be included as may be appropriate for a given implementation of nozzle control system 200.

System 200 may be equipped with one or more image sensors 260. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used to, for example, to detect windshield wipers on a windshield (such as, but not limited to, a front and/or rear windshield) of a vehicle comprising nozzle control system 200. Object detection and recognition techniques may be used to detect windshield wipers and positions of the detected windshield wipers relative to the windshield. In another example, image sensors 260 may be used to detect an amount of fluid on the windshield, for example, by using image data to recognize fluid and/or rain drops. The image sensors 260 may include cameras that may be used with and/or integrated with other proximity sensors 230, such as radar and/or LIDAR sensors or any other sensors capable of recognizing objections in a field of view.

Vehicle systems 258 can include any of a number of different vehicle components or subsystems used to control or monitor various aspects of the vehicle and its performance. In this example, the vehicle systems 258 includes a wiper system 272 (including or an embodiment of windshield wiper system 100 of FIG. 1) that can use data from the liquid presence sensor 222 or other sensors 252 to automatically activate windshield wipers upon detecting fluid on the windshield, such as when the amount of fluid exceeds a threshold. Vehicle systems 258 may also include an object recognition system 274 configured to perform object detection and/or object recognition. Object recognition system 274 may be leveraged, for example, to detect a position of windshields wipers relative to the windshield. Vehicle systems 258 can also include a gas system 276 forcing gas through gas lines. For example, gas system 276 may include pump 136 and one or more lines of FIG. 1 for forcing gas from gas nozzles 130A and 130B according to control exerted by nozzle control circuit 210. Vehicle systems 358 may also include a washer fluid system 278 for spraying washer fluid onto the windshield, such as from container 120 of FIG. 1. Vehicle systems 258 can also include other vehicle systems 282 (e.g., vehicle positioning system; autonomous or semi-autonomous driving systems; Advanced Driver-Assistance Systems (ADAS), such as forward/rear collision detection and warning systems, pedestrian detection systems; and the like).

During operation, nozzle control circuit 210 can receive information from various vehicle sensors 252 and/or systems 258 to determine a manner in which the outputting of gas, e.g., air, from one or more gas nozzles, can be effectuated dependent on the operating characteristics (e.g., needs) of the vehicle as defined by the sensor data and/or system 258. Communication circuit 201 can be used to transmit and receive information to/from nozzle control circuit 210 and sensors 252, and to/from nozzle control circuit 210 and vehicle systems 258. Also, sensors 252 may communicate with vehicle systems 258 directly or indirectly (e.g., via communication circuit 201 or otherwise).

In various embodiments, communication circuit 201 can be configured to receive data and other information from sensors 252 that is used in determining in what manner to output gas (e.g., how to control nozzles). Additionally, communication circuit 201 can be used to send a control signals or other control information to gas system for controlling the one or more gas nozzles to output of gas and according to the operating conditions and characteristics of the vehicle. For example, communication circuit 201 can be used to send control signals to gas nozzles to control one or more of: a direction at which the gas is output from the one or more nozzles; an orientation of the one or more gas nozzles to effectuate the desired direction of gas output; a volume or amount of gas emitted from the one or more gas nozzles; a flow rate of gas from the one or more gas nozzles; a pressure of the gas from the one or more gas nozzles; and a velocity of gas from one or more gas nozzles. As another example, communication circuit 201 can be used to send control signals or other control information to washer fluid system for controlling spray nozzles to output of washer fluid and according to the operating conditions and characteristics of the vehicle. The decision regarding what action nozzle control circuit 210 causes the one or more gas nozzles to take can be made based on the information supplied by sensors 252 and/or systems 258. Examples of this are described in more detail below.

FIGS. 3A-5 illustrate example operations of the windshield wiper system 100 in accordance with embodiments of the presently disclosed technology.

Regarding the embodiments disclosed herein, ECU 150 may comprise nozzle control circuit 210 discussed above in connection with FIG. 2. ECU 150 may receive information from sensors 152, which may be implemented as one or more of sensors 252 discussed above in connection with FIG. 2. Accordingly, based on the information from sensors 152, ECU 150 may be configured to control windshield wiper system 100 to clear the windshield of excess fluid or debris while reducing runoff and/or overflow fluid/debris.

In one example, with reference to FIG. 3A, ECU 150 can be configured to determine a position and/or direction of travel of the blades 112A and/or 112B on the surface of the windshield 104 and control the one or more nozzles 130A/B based on the determined position and/or direction of wiper blades 112A/B. For example, sensors 152 may supply information (also referred to as sensor data) in the form of image data from image sensors 260 or radar/LiDAR data from proximity sensor 226 of a field of view of the windshield 104. The sensor data may be used by object recognition system 274 to determine a position of wiper blades 112A and/or 112B on the windshield (or wiper arms 114A/B can be used as a positional reference point), along with a direction of travel along paths 118A and/or 118B. In another example, sensor data may include position information indicating an angle of rotation and direction executed by actuators 116A and/or 116B, from which ECU 150 can then derive a position and travel direction of the blades 112A and/or 112B based on rotational movement applied to arms 114A and/or 114B. In the example of FIG. 3A, the rotational movement applied to arms 114A/B result in wiper blades 112A/B moving in an arcuate manner (commensurate with/following arrows 118A/B). That is, in this example, wiper blades 112A/B are moving in an upward direction (from a bottom area of windshield 104 (e.g., proximate to cowl 106) towards an upper area of windshield 104, and generally from a left side of vehicle 102 when facing the outer surface of windshield 104 to a right side of vehicle 102.

Based on the determined position and/or location or direction, ECU 150 can be configured to selectively control compressor/pump 136 to force gas 138A and/or 138B out from the one or more gas nozzles 130A and/or 130B, as illustrated in FIG. 3B. For example, based on sensor data the ECU 150 may determine that the blade 112A is positioned adjacent to a bottom edge of the windshield 104 (e.g., near the cowl 106) and that the blade 112A is moving in a first (or forward) direction towards a upper edge of the windshield 104. Responsive to this determination, ECU 150 can be configured to control the compressor/pump 136 to output gas 138A from the one or more gas nozzles 130A toward the upper edge, as shown in FIG. 3B. As a result, any excess fluid 141A′/B′ on the windshield, which without the benefit of embodiments of the present disclosure, would accumulate at/near the A pillars 108A and/or 108B as illustrated in FIG. 3A. Additionally, other fluid or debris, such as rain drops 142 (FIG. 1) may also be pushed by wiper blades 112A/B or may simply accumulate by A-pillars 108A/B, shown as 142′. By using embodiments of the present disclosure, however, in contrast to conventional windshield wiper systems, any fluid, e.g., excess fluid 141A′/B′ or rain/debris 142′, can be redirected towards a center portion(s)/area(s) of the windshield 104 and possibly above the windshield wiper system 100, as illustrated by FIG. 3B. In other words, gas, such as air expelled from one or more of gas nozzles 130A/B can be used to push fluid or debris (being pushed by wiper blades 112A/B towards/otherwise accumulating at) the sides of windshield 104 proximate to A-pillars 108A/B back towards an area(s) of windshield 104 where wiper blades 112A/B can remove such fluid/debris as part of, e.g., a “return” motion or path of movement as illustrated by FIG. 3C

In another example, additionally or alternatively, when the above conditions exist, ECU 150 may cause the one or more gas nozzles 130A and/or 130B to output gas 138A and/or 138B in a direction toward an end of the blades 112A and/or 112B. For example, gas nozzles 130A may be positioned so to expel gas along a length of the blade 112A away from the driver side A-pillar 108A, and the ECU 150 may cause gas to be output along the length of the blade 112A away from driver side A-pillar 108A responsive to the determined position and/or location. In some embodiments, ECU 150 may control actuators 116A to change an orientation of one or more gas nozzles 130A by rotating the one or more gas nozzles 130A along a configured path (represented by arrows 131A) so as to expel gas in the desired direction. Similar operations can be performed on one or more gas nozzles 130B to orient or re-orient gas nozzles 130B as desired (illustrated by arrow 131B).

In another example, as shown in FIG. 4A, ECU 150 may determine that the blade 112A is in a upper position (e.g., an end of the blade 112A is adjacent to the upper edge of the windshield 104) and that the blade 112A is moving in a second (or return) direction towards the lower edge of the windshield 104. Responsive to this determination, ECU 150 can be configured to control the compressor/pump 136 so to direct excess fluid 400A on the windshield downward toward the bottom edge of windshield 104. In one example, as shown in FIG. 4B, the one or more gas nozzles 130A/B may be controlled so as to not output gas, thereby allowing blade 112A to wipe fluid 141A′/B′ toward the bottom edge of windshield 104. In a case where washer fluid 140A/B is sprayed (e.g., due to operation of liquid spray nozzle 124A/B) onto the windshield 104, this embodiment permits washer fluid to be sprayed and then wiped downward by the blades 112A and/or 112B, without fluid being blown in an undesired direction by output gas. However, some examples may be implemented to permit gas to be expelled by one or more gas nozzles 130A and/or 130B so as to direct the fluid as desired.

In some embodiments, ECU 150 may be configured to vary output parameters (e.g., the volume of gas, flow rate, etc.) of gas expelled by the one or more gas nozzles 130A and/or 130B. That is, in one example, one or more gas nozzles 130B may be controlled to expel gas 138B at a first flow rate and/or expel a first volume of gas 138B, while one or more gas nozzles 130A may be controlled to expel gas 138A at a second flow rate and/or expel a second volume of gas 138B. The first volume and/or first flow rate may be different from the second volume and/or flow rate, respectively.

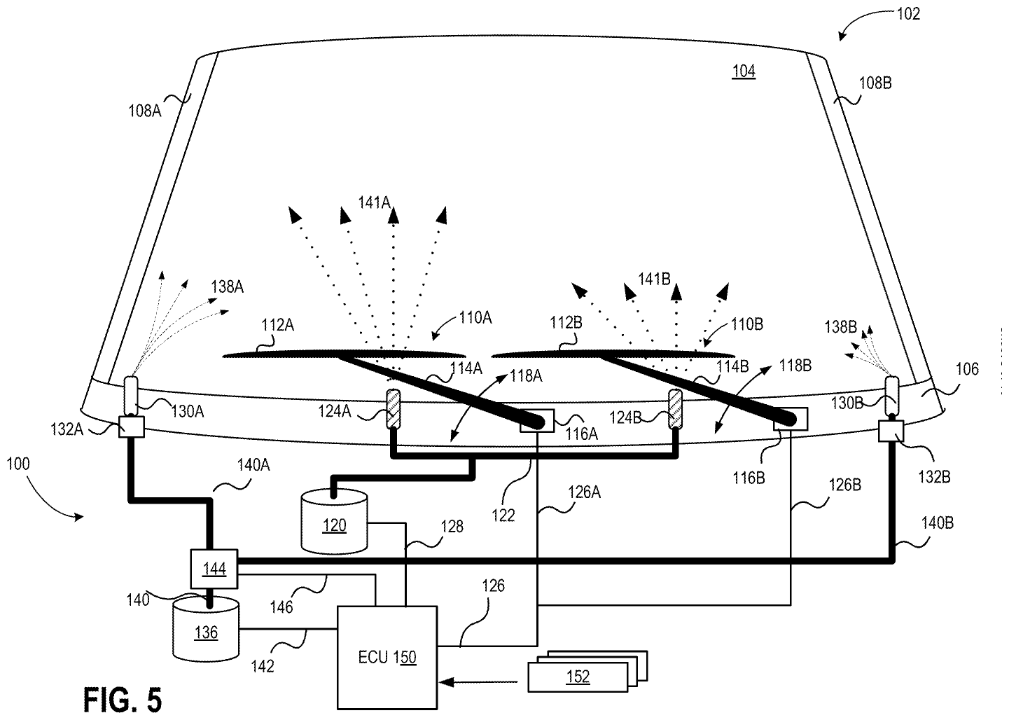

FIG. 5 illustrates an example implementation of varying output parameters, where one or more gas nozzles 130A is expelling gas 13AB at an output parameter that is larger than one or more gas nozzles 130B is outputting gas 13BA. For example, ECU 150 may detect liquid (e.g., rain and/or washer fluid) and/or debris (shown in FIG. 4C as liquid 141A/B) on the windshield 104 based on sensor data from sensors 152 (e.g., liquid presence sensor(s) 222). Using sensor data, ECU 150 may also determine an area of windshield 104 on which liquid 402 is present and which windshield wiper assembly 110A or 110B corresponds to the determined area (e.g., which path 118A or 118B traverses the determined area). The ECU 150 may also determine an amount of liquid or debris present thereon, and compare the amount to a set threshold amount. Responsive to the determined amount being below the set threshold amount, ECU 150 may cause the one or more gas nozzles to output gas, corresponding to a determined area of windshield 104, at a lower flow rate or lower volume, shown as gas 138B in FIG. 5. On the other hand, the ECU 150 may cause the one or more gas nozzles, corresponding to the determined area of windshield 104, to output gas at a higher flow rate or larger volume responsive to the amount of liquid being equal to or exceeding the set threshold, e.g., gas 138A from gas nozzle 130A.

Flow rate may be controlled by adjusting a volume of gas forced through gas line 140 per unit of time, adjusting a pressure at which gas forced through gas line 140, and/or adjusting the velocity at which the gas forced through gas line 140. As another example, apertures of the gas nozzles 130A and/or 130B can be controlled to constrict or increase in size so as to control pressure of the gas. Accordingly, embodiments disclosed herein can vary the volume and/or flow rate of the gas 138A and 138B between a minimum value (e.g., none) to a maximum value based on an amount of fluid (e.g., washer fluid and/or rain) detected on the windshield. The volume and/or flow rate may be proportional to the amount of fluid or debris present on the windshield.

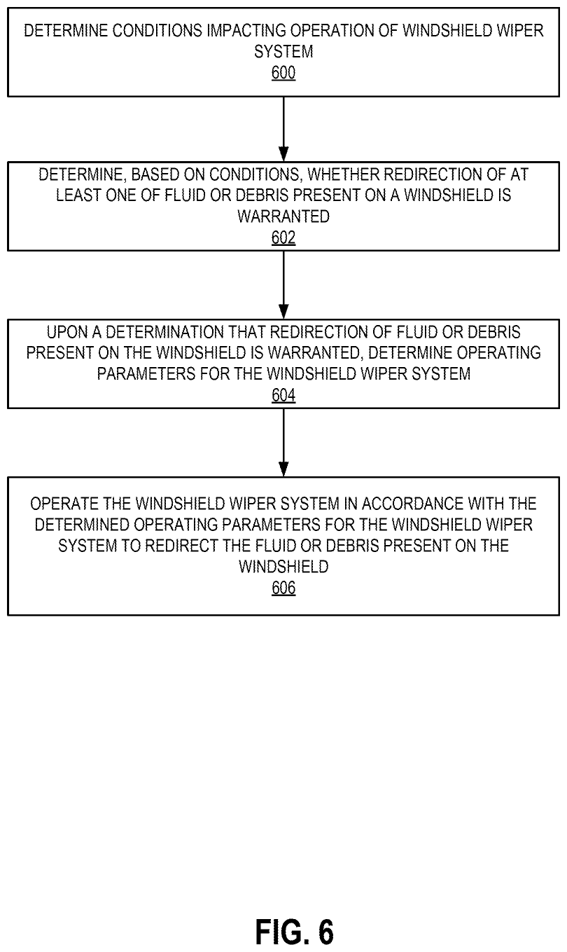

FIG. 6 illustrates a plurality of operations that may be performed by, e.g., nozzle control circuit 210, to selectively operate one or more gas nozzles to facilitate the reduction or elimination of fluid or debris runoff on vehicles as a result of environmental conditions (e.g., rainy conditions) and/or operation of vehicles' windshield wipers.

At operation 600, conditions impacting operation of a windshield wiper system are determined. As noted above, various sources of vehicle operating conditions as well as environmental conditions can provide information/data regarding a vehicle's operating conditions/environmental conditions. Such sources may include on-vehicle sensors, such as cameras, rain sensors, and the like. Such conditions may include positioning of the wiper blades during use, the direction of travel of the wiper blades, whether fluid/debris is present on the windshield, etc.

At operation 602, based on the determined conditions, a determination can be made regarding whether redirection of at least one of fluid and debris present on a windshield is warranted. As discussed above, based on the position/motion of a vehicle's windshield wipers and/or based on the environmental conditions, fluid or debris may accumulate near one or more A-pillars of the vehicle, in which case, nozzle control circuit 210 can control one or more gas nozzles to expel gas, such as air, to redirect the accumulated fluid/debris runoff.

Accordingly, at operation 604, upon a determination that redirection of fluid/debris present on the windshield is warranted, operating parameters for the windshield wiper system are determined. For example, a determination may be made based on the determined conditions, one side of a vehicle's windshield has fluid runoff that should be dispersed or redirected, while another side is relatively clear or has not reached/surpassed a fluid/debris threshold. Accordingly, nozzle control circuit 203 may control a gas nozzle operative on the side of the vehicle's windshield with fluid runoff necessitating redirection to expel an appropriate amount of gas, e.g., air, to move or redirect the fluid runoff to an area where a windshield wiper(s) can handle its removal, e.g., towards a central area of the windshield. On the side where fluid runoff is minimal, nozzle control circuit 203 may prohibit or control the corresponding gas nozzle to not expel gas.

It should be understood that variations regarding implementation and/or operation of a windshield wiper system, such as system 100 described herein, are contemplated as would be understood by those of ordinary skill in the art. For example, instead of a single switch 144, each gas nozzle/actuator assembly may be controlled or enabled/disabled with its own, associated switch or controller (now shown).

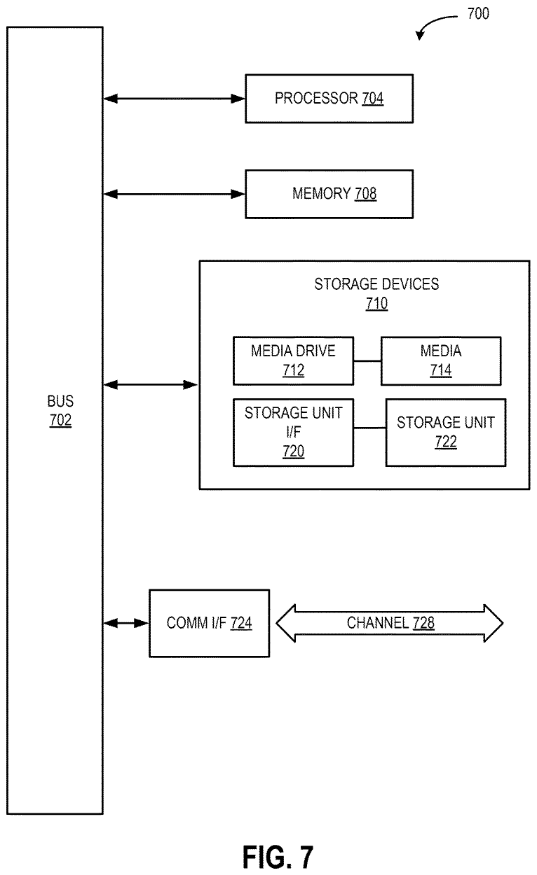

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up nozzle control system 200 of FIG. 2 and/or ECU 150 of FIG. 1. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
determining, by a control circuit, conditions impacting operation of a windshield wiper system;
determining, by the control circuit and based on the determined conditions, whether redirection of at least one of fluid or debris present on a windshield is warranted;
upon a determination that redirection of the least one of fluid or debris present on the windshield, determining operating parameters for the windshield wiper system;
operating, by the control circuit, the windshield wiper system in accordance with the determined operating parameters for the windshield wiper system to redirect the at least one of the fluid or debris present on the windshield.

2. The method of claim 1, wherein the determined operating parameters comprise at least one of a direction of operation and an intensity of operation of the windshield wiper system.

3. The method of claim 2, wherein the windshield wiper system comprises at least one nozzle configured to expel a gas to effectuate redirection of the at least one of the fluid or debris on the windshield, the direction of operation comprising directing the at least one nozzle in a direction to effectuate the redirection of the at least one of the fluid or debris on the windshield.

4. The method of claim 1, wherein determining whether redirection of at least one of fluid or debris present on a windshield is warranted comprises, the control circuit receiving sensor information regarding the presence of an accumulation of or runoff made up of the at least one of the fluid or debris proximate to a vehicle A-pillar.

5. A system, comprising:
a wiper blade;
a wiper arm operatively connected to the wiper blade and to an actuator configured to move the wiper arm on a surface such that the wiper blade follows a path for clearing at least one of fluid or debris from the path on the surface;
a nozzle configured to expel gas to redirect at least one of accumulated or runoff fluid or debris outside the path to within the path allowing the wiper blade to clear the at least one of the redirected accumulated or runoff fluid or debris.

6. The system of claim 5, further comprising a nozzle control circuit controlling the expelling of the gas from the nozzle.

7. The system of claim 6, wherein the nozzle control circuit controls at least one of a direction in which the gas is expelled from the nozzle, an amount of gas that is expelled from the nozzle, and a pressure at which the gas is expelled from the nozzle.

8. The system of claim 5, further comprising:
another wiper blade;
another wiper arm operatively connected to the other wiper blade and to another actuator configured to move the other wiper arm on a surface such that the other wiper blade follows another path for clearing at least one of fluid or debris from the other path on the surface; and
another nozzle configured to expel additional gas to redirect at least one of accumulated or runoff fluid or debris outside the other path to within the other path allowing the other wiper blade to clear the at least one of the redirected accumulated or runoff fluid or debris.

9. The system of claim 8, wherein the nozzle control circuit further controls the expelling of the additional gas from the other nozzle.

10. The system of claim 9, wherein the nozzle control circuit controls at least one of a direction in which the additional gas is expelled from the other nozzle, an amount of the additional gas that is expelled from the other nozzle, and a pressure at which the additional gas is expelled from the other nozzle.

11. The system of claim 10, wherein the nozzle control circuit separately controls the expelling of the gas and the additional gas from the nozzle and the other nozzle, respectively.
